(19) United States
(12) Patent Application Publication
(10) Pub. No.: US 2024/0106827 A1
(43) Pub. Date: Mar. 28, 2024

(54) DISTRIBUTED ACCESS POLICIES

(71) Applicant: Red Hat, Inc., Raleigh, NC (US)

(72) Inventors: Leigh Griffin, Waterford (IE); Aoife E. Moloney, Waterford (IE)

(21) Appl. No.: 17/952,887

(22) Filed: Sep. 26, 2022

(51) Int. Cl. H04L 9/40

(52) U.S. Cl. CPC H04L 63/10; H04L 63/0884; H04L 63/20

(57) ABSTRACT

A first computing device of a plurality of computing devices in communication with one another via a communications channel receives, from a requesting computing device, an access request that identifies a subject, a resource identifier that identifies a resource, and an action, the first computing device having a set of access policies, each access policy corresponding to a particular resource of a plurality of resources. The first computing device determines that the resource identifier identifies a resource that is not governed by an access policy in the set of access policies. The first computing device sends, to the communications channel, the access request. The first computing device receives an access request decision from a second computing device of the plurality of computing devices, and the first computing device grants or denies access to the resource by the user based on the access request decision.

### BACKGROUND

Computing devices often implement access policies that govern access to a resource, such as a file, a database, an application programming interface, a communication interface, or the like. When a request to access the resource is made, the access policy determines whether the requestor has the rights to access the resource, and the requestor may be granted access to the resource or denied access to the resource based on the access policy.

### SUMMARY

The examples disclosed herein implement distributed access policies.

In one example a method is included. The method includes receiving, by a first computing device of a plurality of computing devices in communication with one another via a communications channel, from a requesting computing device, an access request that identifies a subject (e.g., a requestor), a resource identifier that identifies a resource, and an action, the first computing device having a set of access policies, each access policy corresponding to a particular resource of a plurality of resources. The method further includes determining, by the first computing device, that the resource identifier identifies a resource that is not governed by an access policy in the set of access policies. The method further includes sending, by the first computing device to the communications channel, the access request. The method further includes receiving, by the first computing device, an access request decision from a second computing device of the plurality of computing devices. The method further includes granting or denying access to the resource by the user based on the access request decision.

In another example a computing device is included. The computing device includes a memory, and a processor device coupled to the memory to receive, via a communications channel, from a requesting computing device, an access request that identifies a subject, a resource identifier that identifies a resource, and an action, the first computing device having a set of access policies, each access policy corresponding to a particular resource of a plurality of resources. The processor device is further to determine that the resource identifier identifies a resource that is not governed by an access policy in the set of access policies. The processor device is further to send, to the communications channel, the access request. The processor device is further to receive an access request decision from a second computing device of the plurality of computing devices. The processor device is further to grant or deny access to the resource by the user based on the access request decision.

In another example a non-transitory computer-readable storage medium is included. The non-transitory computer-readable storage medium includes executable instructions to cause a processor device to receive, via a communications channel, from a requesting computing device, an access request that identifies a subject, a resource identifier that identifies a resource, and an action, the first computing device having a set of access policies, each access policy corresponding to a particular resource of a plurality of resources. The instructions further cause the processor device to determine that the resource identifier identifies a resource that is not governed by an access policy in the set of access policies. The instructions further cause the processor device to send, to the communications channel, the access request. The instructions further cause the processor device to receive an access request decision from a second computing device of the plurality of computing devices. The instructions further cause the processor device to grant or deny access to the resource by the user based on the access request decision.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which distributed access policies may be implemented according to some examples;

FIG. 2 is a sequence diagram illustrating messages communicated between and actions taken by one or more of the computing devices in response to the receipt of an access request according to one example;

FIG. 3 is a sequence diagram illustrating messages communicated between and actions taken by one or more of the computing devices in response to the receipt of an access request according to another example;

FIG. 4 is a sequence diagram illustrating messages communicated between and actions taken by one or more of the computing devices in response to the receipt of an access request according to another example;

FIG. 5 is a sequence diagram illustrating messages communicated between and actions taken by one or more of the computing devices in response to the receipt of an access request according to another example;

FIG. 6 is a flowchart of a method for distributed access policies according to one implementation;

FIG. 7 is a block diagram of an environment suitable for determining a distribution of access policies according to one implementation;

FIG. 8 is a simplified block diagram of the environment illustrated in FIG. 1 according to one implementation; and

FIG. 9 is a block diagram of a computing device suitable for implementing the examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context.

Computing devices often implement access policies that govern access to a resource, such as a file, a database, an application programming interface, a communication interface, or the like. When a request to access the resource is made, the access policy determines whether the requestor has the rights to access the resource, and the requestor may be granted access to the resource or denied access to the resource based on the access policy.

In a computer network that includes a plurality of computing devices access policies may be maintained by the computing device that controls the resource, or alternatively, in some environments, access policies are maintained in a centralized requests to resources may be either analyzed maintained in a centralized location.

An access policy may include a substantial amount of data that identifies a plurality of different requestors that are permitted access, and for each such requestor, the specific access rights that are granted, such as read rights, write rights, delete rights, or the like. Such access policies may require a substantial amount of disk space and/or limited random access memory, and to evaluate an access request against an access policy may take a relatively substantial amount of processor utilization.

Certain computing devices are designed intentionally to be resource constrained because they have a specific purpose and to perform the specific purpose need only a certain amount of memory, storage and processing power. Providing such a computing device with only the resources needed helps reduce costs and, where important, the size, of the computing device. An Internet of Things (IoT) computing device may be an example of a resource constrained computing device.

However, even resource-constrained computing devices may control resources, such as a sensor, a switch, a file, or a piece of data that another computing device may wish to access. It may also be desirable to control access to resources through access policies. However, such computing devices may not have sufficient resources to implement such access policies, or, even if initially capable of implementing access policies, may, as the access policies grow over time and/or the load on the computing device grows over time, eventually be unable to process the access policies while providing the primary functionality the computing device was designed to provide.

The examples disclosed herein implement distributed access policies. A plurality of access policies are distributed across a plurality of computing devices that are communicatively coupled to one another. A first computing device that has sufficient resources may govern the access policies for a resource controlled by a second computing device. A request to access the resource may be provided to the first computing device, and the first computing device may determine that the requestor, based on the access policy that corresponds to the resource, has the right to access the resource. The first computing device may then provide the requestor authentication information such that, when presented by the requestor to the second computing device, the second computing device can ensure that the requestor has been granted the right to access the resource.

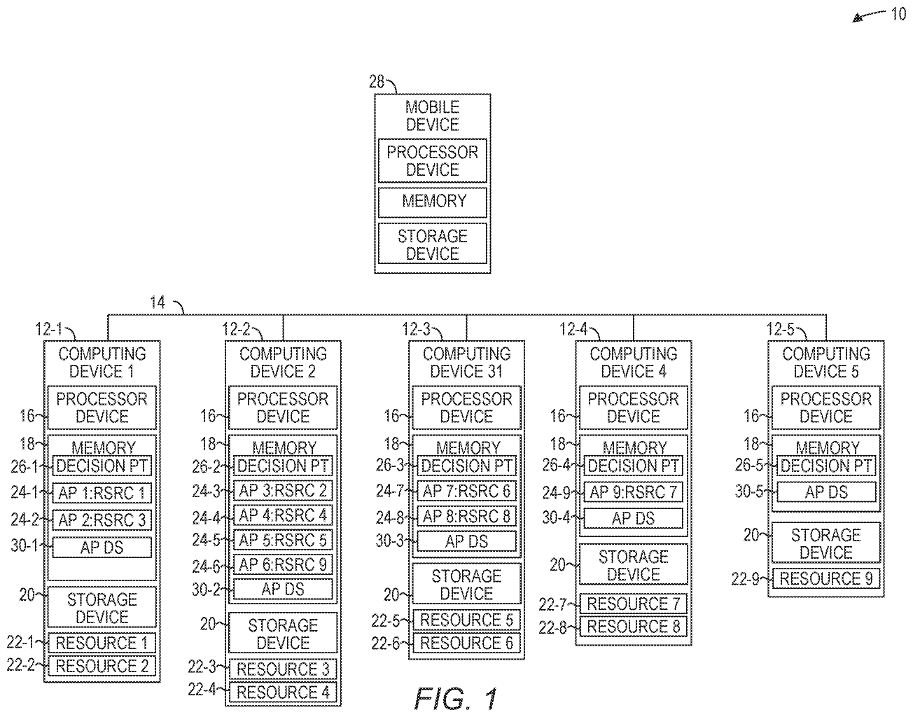

FIG. 1 is a block diagram of an environment 10 in which distributed access policies may be implemented according to some examples. The environment 10 includes a plurality of computing devices 12-1-12-5 (generally, computing devices 12) that are communicatively coupled to one another via a communications channel 14. The communications channel 14 may comprise a wireless communications medium, a wired communications medium, or a combination of both a wireless and wired communications medium. The computing devices 12 may each include a processor device 16, a memory 18, and a storage device 20.

The computing device 12-1 controls a resource 22-1 and 22-2. The term “resource” as used herein refers to any item that can be individually accessed. An access may, by way of non-limiting example, comprise a read, a write, a modification, an activation such as being powered-on or powered-off, or the like. Non-limiting examples of resources include a file, a database, a light, a speaker, a switch, a sensor, a unit of data, a thermostat, and the like. The term “controls” used in conjunction with a resource 22 refers to the ability of the computing device to directly access the resource. For example, the resources 22-1 and 22-2 may be integral with the computing device 12-1, maintained on or within the computing device 12-1, or be directly connected to the computing device 12-1.

The computing device 12-2 controls a resource 22-3 and 22-4, the computing device 12-3 controls a resource 22-5 and 22-6, the computing device 12-4 controls a resource 22-7 and 22-8, and the computing device 12-5 controls a resource 22-9. While for purposes of illustration the computing devices 12 are illustrated as controlling one or two resources 22, in practice, a computing devices 12 may control any number of resources, such tens, hundreds or thousands of resources.

The computing device 12-1 contains an access policy 24-1 that governs access to the resource 22-1, and an access policy 24-2 that governs access to the resource 22-3 that is controlled by the computing device 12-2. The computing device 12-2 contains an access policy 24-3 that governs access to the resource 22-2, an access policy 24-4 that governs access to the resource 22-4, an access policy 24-5 that governs access to the resource 22-5, and an access policy 24-6 that governs access to the resource 22-9. The computing device 12-3 contains an access policy 24-7 that governs access to the resource 22-6, and an access policy 24-8 that governs access to the resource 22-8. The computing device 12-4 contains an access policy 24-9 that governs access to the resource 22-7. The computing device 12-5 contains no access policies. The access policies 24-1-24-9 may be referred to generally as access policies 24.

Each access policy 24 may differ in size, and in the amount of processing power required to analyze the access policy 24 upon the receipt of an access request. The size of an access policy 24 may differ based on, for example, the number of different requestors identified in the access policy 24, the number of different potential access actions that a resource 22 can implement, the number of different actions granted to requestors, the number of requestors that have been given a right to access the resource 22, and the like. As will be described in greater detail below, the access policies 24 may be distributed to particular computing devices 12 based on various criteria.

The computing devices 12-1-12-5 include corresponding decision points 26-1-26-5 (generally, decision points 26). Each decision point 26 operates similarly. The decision points 26 implement certain access policy functionality. As an example, assume that a mobile device 28 is in wireless communication, such as via WiFi, Bluetooth, ZigBee, or the like, with the computing device 12-1. The mobile device 28 attempts to access a resource on one of the computing devices 12. The decision point 26-1 receives the access request for the particular resource 22 and determines whether the computing device 12-1 governs access to the resource 22. As discussed herein, the computing device 12 that has a particular access policy 24 that governs access to a particular resource 22 is the computing device 12 that governs access to the resource 22. If the computing device 12-1 has the access policy 24 that governs access to the particular resource 22, the decision point 26-1 accesses the access policy 24 and determines whether the requestor, in this example the mobile device 28, is permitted to access the resource 22, and grants or denies the access request. If the computing device 12-1 does not have the access policy 24 that governs access to the particular resource 22, the decision point 26-1 may send the access request to one or more of the other decision points 26-2-26-5. The particular decision point 26-2-26-5 that contains the access policy 24 that governs the access request may receive the access request, analyze the corresponding access policy 24, and send to the decision point 26-1 a grant or deny decision. The decision point 26-1 may then send a grant or deny decision to the mobile device 28.

In some implementations each computing device 12 may periodically, intermittently, or in response to some event or at a particular time, such as during the initiation of the computing device 12, broadcast, via the communication channel 14, information that identifies the resources 22 that are governed by the set of access policies 24 of the respective computing device 12. As an example, the computing device 12-1 may broadcast information that identifies the resources 22-1 and 22-3 as being governed by the computing device 12-1. The information may include an address of the computing device 12-1. Each computing device 12 may also broadcast information that identifies the resources 22 that are controlled by the respective computing device 12. For example, the computing device 12-1 may broadcast information that identifies the resources 22-1 and 22-2 as being controlled by the computing device 12-1. The information may include unique identifiers of the resources 22-1 and 22-2. In some implementations, a publish/subscribe message bus protocol may be used by the computing devices 12 to communicate with one another.

The computing device 12-1 may also receive the broadcasts of the computing devices 12-2-12-4, or subscribe to events published by the computing devices 12-2-12-4, and build an access policy (AP) data structure (DS) 30-1. The AP DS 30-1 contains information that identifies each of the computing devices 12-1-12-5, which resources 22 are controlled by the computing devices 12, and which resources 22 are governed by the computing devices 12. In this implementation, upon receipt of an access request for a particular resource 22, the computing device 12-1 may access the AP DS 30-1 to determine which computing device 12 governs access to the particular resource 22 and send the access request directly to the computing device 12 rather than broadcast the access request to all the computing devices 12.

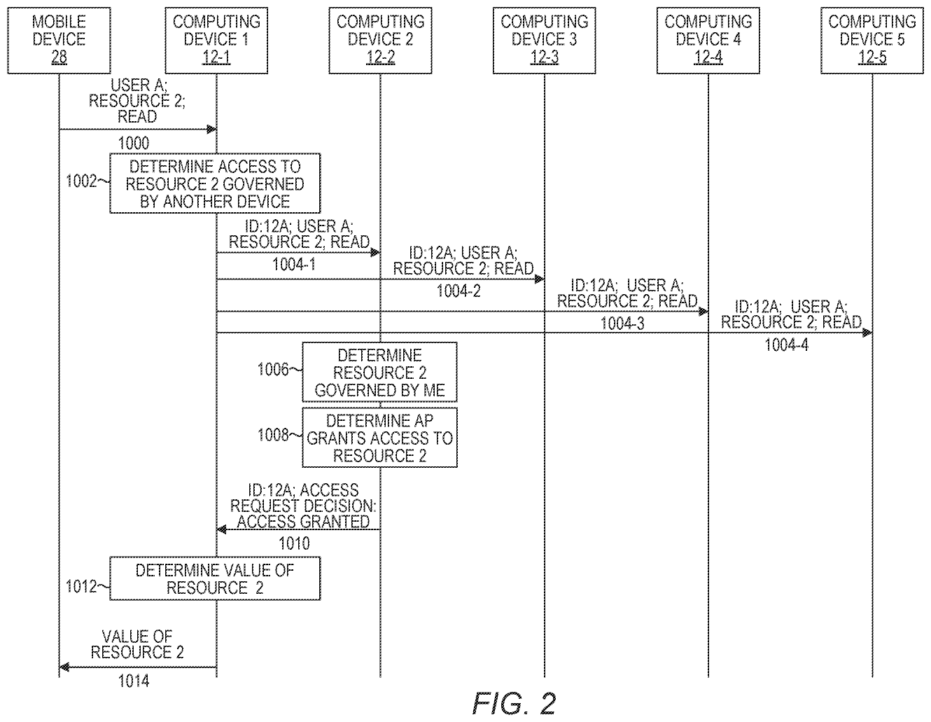

FIG. 2 is a sequence diagram illustrating messages communicated between and actions taken by one or more of the computing devices 12 in response to the receipt of an access request according to one example. In this example, the mobile device 28 is in direct wireless communication with the computing device 12-1. The computing devices 12, in this example, may be resource-constrained computing devices associated with appliances, such as a refrigerator, an oven, an air conditioning unit, a thermostat, a gas fireplace controller, or the like. In this example, the computing device 12-1 may comprise a controller that controls the two resources 22-1 and 22-2. The resource 22-2 may comprise a temperature sensor that identifies a temperature of an environment, and the resource 22-1 may comprise a control system that can be set to either increase the temperature of the environment or decrease the temperature of the environment.

The mobile device 28 may be operated by a user who desires to determine the temperature of the environment and thus read the resource 22-2. The mobile device 28 may present a user interface (UI) that allows the user to request the temperature of the environment. The mobile device 28 sends, to the computing device 12-1, an access request that includes a subject, a resource identifier that identifies the resource 22-2, and an action (step 1000). The subject may comprise information that is used by the computing devices 12 for authentication purposes. For example, the subject may comprise a user identifier that identifies the user, or may comprise information that identifies the mobile device 28. What constitutes a user may differ based on the particular implementation and on what information is used in the environment 10 for authentication purposes. The action in this example comprises a read action.

The decision point 26-1 determines that the computing device 12-1 does not govern access to the resource 22-2 (step 1002). The decision point 26-1 may make this determination by determining that the access policies 24-1 and 24-2 do not govern access to the resource 22-2. In examples where the decision point 26-1 generates the AP DS 30-1, the decision point 26-1 may make this determination by accessing the AP DS 30-1. The decision point 26-1 may generate a unique identifier (ID), in this example “12A” that uniquely identifies the access request, and store the access request and the unique ID for subsequent access. The computing device 12-1 broadcasts the unique ID and the access request to the computing devices 12-2-12-5 (steps 1004-1-1004-4).

The decision point 26-2 determines that the computing device 12-2 contains the access policy 24-3 that governs access to the resource 22-2 (step 1006). The decision points 26-3-28-5 each determine that they do not govern access to the resource 22-2. The decision point 26-2 interprets the access policy 24-3 based on the access request and determines that the access request is to be granted (step 1008). In particular, the decision point 26-2 determines that the access policy 24-3 indicates that the user identified in the access request has been granted read access rights to the resource 22-2.

The computing device 12-2 sends an access request decision that includes the unique ID and information that indicates that the access request is granted to the computing device 12-1 (step 1010). The computing device 12-1 receives the access request decision and grants access to the user based on the access request decision. In particular, in this example because the computing device 12-1 controls access to the resource 22-2, the computing device 12-1 may read the resource 22-2. In this example, the read action returns the current value of the temperature sensor which identifies the current temperature of the environment (step 1012). The computing device 12-1 then sends the current temperature to the mobile device 28 (step 1014).

It is noted that because the decision points 26-1-26-5 are components of the computing devices 12-1-12-5, functionality implemented by the decision points 26-1-26-5 may be attributed to the respective computing devices 12-1-12-5 generally. Moreover, in examples where the decision points 26-1-26-5 comprise software instructions that program the processor devices 16 to carry out functionality discussed herein, functionality implemented by the decision points 26-1-26-5 may be attributed herein to the respective processor devices 16.

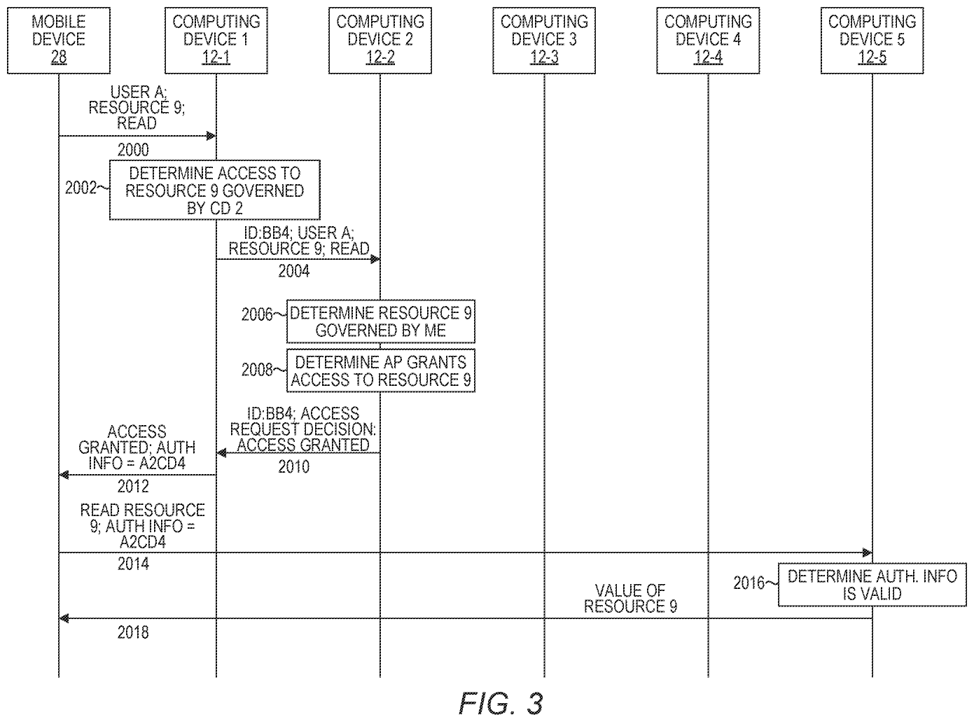

FIG. 3 is a sequence diagram illustrating messages communicated between and actions taken by one or more of the computing devices 12 in response to the receipt of an access request according to another example. In this example, the mobile device 28 is in direct wireless communication with the computing device 12-1 and the computing device 12-5. The computing devices 12, in this example, again, may be resource-constrained computing devices associated with appliances, such as a refrigerator, an oven, an air conditioning unit, a thermostat, a gas fireplace controller, or the like. In this example, the computing device 12-5 is a thermostat that controls the resource 22-9, which is the current temperature set of the thermostat. The resource 22-9 can be read to determine the current temperature set of the thermostat or written to alter the current temperature set of the thermostat.

The mobile device 28 may be operated by a user who desires to determine the temperature set of the thermostat and thus desires to read the resource 22-9. The mobile device 28 may present a UI that allows the user to request the temperature set of the thermostat. The mobile device 28 sends, to the computing device 12-1, an access request that includes a subject, a resource identifier that identifies the resource 22-9, and an action (step 2000). Again, the subject may comprise a user identifier that identifies the user, may comprise information that identifies the mobile device 28, or may comprise any other suitable information used for authentication purposes in the environment 10.

The computing device 12-1 determines that the computing device 12-1 does not govern access to the resource 22-9 (step 2002). In this example, the computing device 12-1 has generated the AP DS 30-1, and the computing device 12-1 accesses the AP DS 30-1. The computing device 12-1 determines that the computing device 12-2 governs access to the resource 22-9. The computing device 12-1 generates a unique ID, in this example “BB4” that uniquely identifies the access request, and stores the access request and the unique ID for subsequent access. The computing device 12-1 sends the unique ID and the access request directly to the computing device 12-2 using an address of the computing device 12-2 (step 2004).

The computing device 12-2 determines that the computing device 12-2 contains the access policy 24-3 that governs access to the resource 22-9 (step 2006). The computing device 12-2 interprets the access policy 24-6 based on the access request and determines that the access request is to be granted (step 2008). In particular, the computing device 12-2 determines that the access policy 24-6 indicates that the user identified in the access request has been granted read access rights to the resource 22-9.

The computing device 12-2 sends an access request decision that includes the unique ID and information that indicates that the access request is granted to the computing device 12-1 (step 2010). The computing device 12-1 receives the access request decision and generates authentication information, that, when presented to the computing device 12-5, validates to the computing device 12-5 that the mobile device 28 has been granted access to the resource 22-9. The computing device 12-1 sends an access request granted message to the mobile device 28 that includes the authentication information (step 2012). The mobile device 28 then sends to the computing device 12-5, directly or indirectly through the computing device 12-1, a request to read the resource 12-9 along with the authentication information (step 2014). The computing device 12-5 receives the request and validates the authentication information (step 2016). The computing device 12-5 reads the resource 12-9, and sends the current temperature set of the thermostat to the mobile device 28 (step 2018).

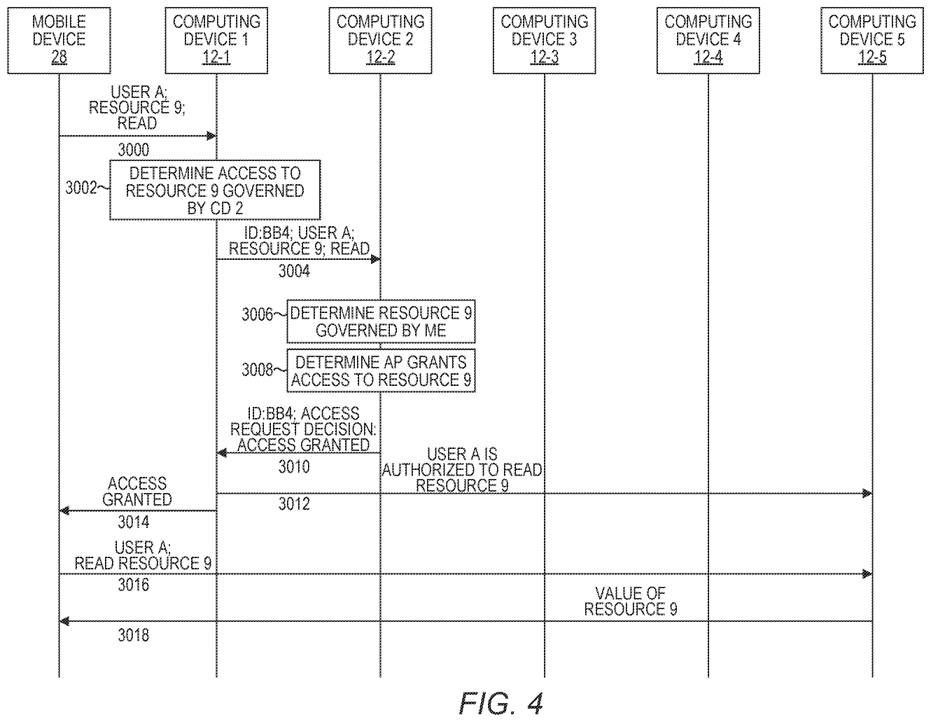

FIG. 4 is a sequence diagram illustrating messages communicated between and actions taken by one or more of the computing devices 12 in response to the receipt of an access request according to another example. FIG. 4 is substantially similar to the example discussed above with regard to FIG. 3. The initial steps 3000-3010 are the same as the steps 2000-2010 and for that sake of brevity will not be repeated. After the computing device 12-1 determines that the access request is granted, in this example, the computing device 12-1 sends information to the computing device 12-5 that the user A is authorized to read the resource 22-9 (step 3012). This may be time-limited authorization, such as for the next 60 seconds, five minutes, or the like. The computing device 12-5 receives the information. The computing device 12-1 sends information to the mobile device 28 that the access request has been granted (step 3014). The mobile device 28 may then send a read request to the computing device 12-5 along with information that identifies the user A (step 3016). The computing device 12-5 receives the request and, based on receiving the information from the computing device 12-1 that indicates the user A was authorized to read the resource 22-9, accesses the resource 22-9 and provides the current temperature set to the mobile device 28 (step 3018).

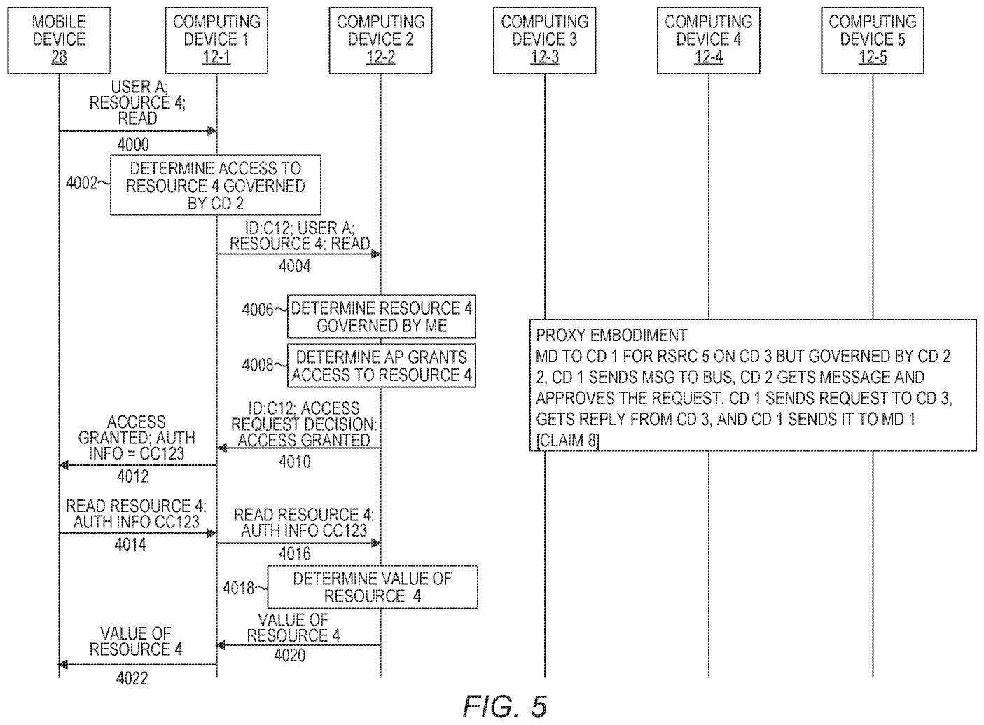

FIG. 5 is a sequence diagram illustrating messages communicated between and actions taken by one or more of the computing devices 12 in response to the receipt of an access request according to another example. In this example, the mobile device 28 is in direct wireless communication only with the computing device 12-1. The mobile device 28 sends, to the computing device 12-1, an access request that includes a subject, a resource identifier that identifies the resource 22-4, and an action (step 4000). Again, the subject may comprise a user identifier that identifies the user, may comprise information that identifies the mobile device 28, or may comprise any other suitable information used for authentication purposes in the environment 10.

The computing device 12-1 determines that the computing device 12-1 does not govern access to the resource 22-4 (step 4002). In this example, the computing device 12-1 has generated the AP DS 30-1, and the computing device 12-1 accesses the AP DS 30-1. The computing device 12-1 determines that the computing device 12-2 governs access to the resource 22-4. The computing device 12-1 generates a unique ID, in this example “C12” that uniquely identifies the access request, and stores the access request and the unique ID for subsequent access. The computing device 12-1 sends the unique ID and the access request directly to the computing device 12-2 using an address of the computing device 12-2 (step 4004).

The computing device 12-2 determines that the computing device 12-2 contains the access policy 24-4 that governs access to the resource 22-4 (step 4006). The computing device 12-2 interprets the access policy 24-4 based on the access request and determines that the access request is to be granted (step 4008). In particular, the computing device 12-2 determines that the access policy 24-4 indicates that the user identified in the access request has been granted read access rights to the resource 22-4.

The computing device 12-2 sends an access request decision that includes the unique ID and information that indicates that the access request is granted to the computing device 12-1 (step 4010). The computing device 12-1 sends an access request granted message to the mobile device 28 that includes authentication information (step 4012). In this example, the mobile device 28 cannot directly reach the computing device 12-2 and sends the computing device 12-1 a proxy request to read the resource 22-4 (step 4014). The proxy request may include the authentication information provided by the computing device 12-1. The computing device 12-1 receives the proxy request, and sends a read request for the resource 22-4 to the computing device 12-2 (step 4016). The computing device 12-2 receives the request and determines that the authentication information is valid. The computing device 12-2 reads the resource 22-4 and sends the value of the resource 22-4 to the computing device 12-1 (steps 4018, 4020). The computing device 12-1 sends the value of the resource 22-4 to the mobile device 28 (step 4022).

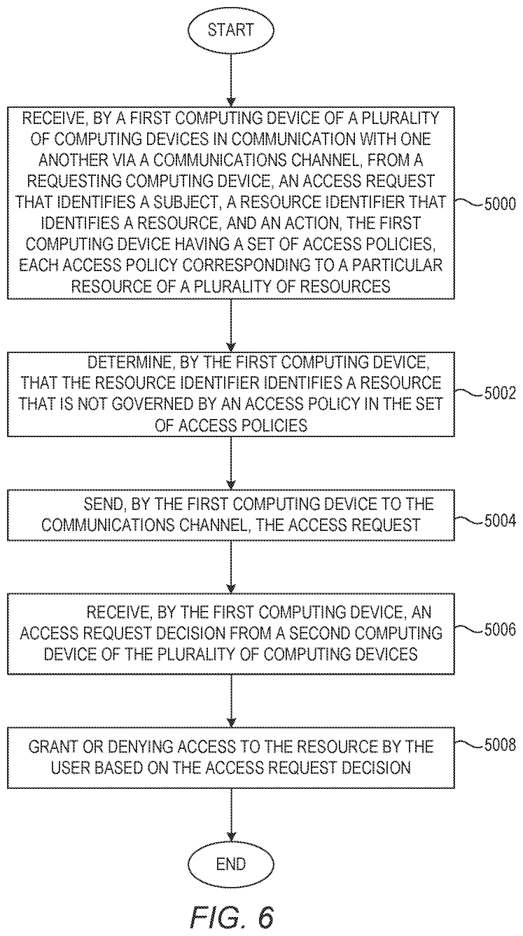

FIG. 6 is a flowchart of a method for distributed access policies according to one implementation. FIG. 6 will be discussed in conjunction with FIG. 1. The computing device 12-1 (e.g., a first computing device) receives, via communications channel 14, from a requesting computing device, in this example the mobile device 28, an access request that identifies a subject, a resource identifier that identifies the resource 22-2, and an action. The computing device 12-1 has the set of access policies 24-1 and 24-2, each access policy 24 corresponding to a particular resource 22 of the plurality of resources 22-1-22-9 (FIG. 6, block 5000). In this example, the access policy 24-1 corresponds to the resource 22-1 and the access policy 24-2 corresponds to the resource 22-3.

The computing device 12-1 determines that the resource identifier identifies the resource 22-2 that is not governed by an access policy 24 in the set of access policies 24-1 and 24-2 (FIG. 6, block 5002). The computing device 12-1 sends, to the communications channel 14, the access request (FIG. 6, block 5004). The computing device 12-1 receives an access request decision from the computing device 12-2 (e.g., a second computing device) (FIG. 6, block 5006). The computing device 12-1 grants or denies access to the resource 22-2 by the user based on the access request decision (FIG. 6, block 5008).

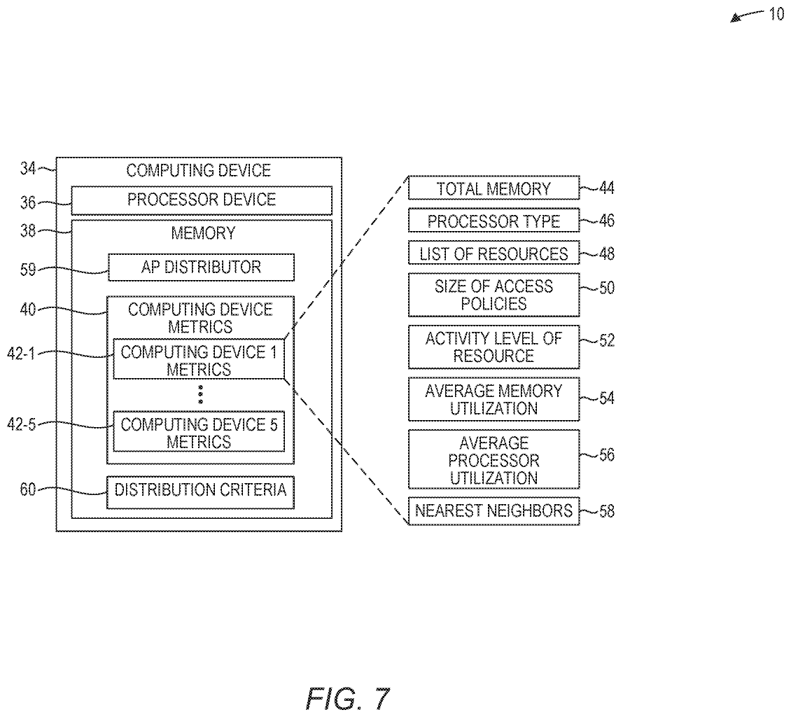

FIG. 7 is a block diagram of an environment 32 suitable for determining a distribution of the access policies 24-1-24-9 according to one implementation. The environment 32 includes a computing device 34, which in turn includes a processor device 36 and a memory 38. The computing device 34 includes, or has access to, computing device metrics 40. The computing device metrics 40 comprises a plurality of computing device metric records 42-1-42-5 (generally, computing device metric records 42), each of which corresponds to one of the computing devices 12-1-12-5.

Each computing device metric record 42 may include information about the corresponding computing device 12. The information may include memory information 44 that identifies a total amount of memory 18 implemented on the corresponding computing device 12, and processor type information 46 that contains information that indicates a processing power level of the processor device 16 of the corresponding computing device 12. The information includes a list 48 of the resources 22 that are controlled by the corresponding computing device 12, which may also identify a type of resource (e.g., file, sensor, switch, etc.). The information includes a size of access policies 50 that identifies the size, in bytes, of the access policies 24 that correspond to the resources 22 identified in the list 48 of the resources 22. The information may also include information obtained over time while the computing devices 12 were operating. For example, the information may include the activity level 52 of the resources 22 over a period of time, such as a day, a week, a month, or any other suitable or desirable period of time. The activity level 52 may indicate how many accesses were requested against the resource 22 during the period of time. The information may include an average memory utilization 54 of the memory 18 of the corresponding computing device 12 over the period of time. The information may include an average processor utilization 56 of the processor device 16 of the corresponding computing device 12 over the period of time. The information may also include nearest neighbor information 58 to facilitate the generation of a physical topology that identifies which computing devices 12 are nearer other computing device 12.

An access policy (AP) distributor 59 may access the computing device metrics 40 and, based on the computing device metrics 40 and distribution criteria 60 allocate each access policy 24 to a particular computing device 12. As a relatively simple example with regard to FIG. 1, the computing device metric record 42-5 may indicate that the resource 22-9 is a highly active resource, that the computing device 12-5 is severely constrained, and have little excess memory 18 available (e.g., a delta between the total memory of the computing device 12-5 and the average memory utilization of the computing device 12-5) and contain a relatively weak processor device 16. The computing device metric record 42-2 may indicate that the computing device 12-2 has a relatively large amount of excess memory 18 and a relatively powerful processor device 16. Thus, the AP distributor 59, based on this information may determine that the AP 24-6 that governs the resource 22-9 will be maintained by the computing device 12-2.

The AP distributor 59 may then send the APs 24-1-24-9 to the computing devices 12-1-12-4 as illustrated in FIG. 1. The computing device metrics 40 may be continually updated, and the AP distributor 59 may periodically, intermittently or in response to some event, such as the addition of a new access policy or a new computing device 12, determine again an appropriate distribution of the APs 24 based on the computing device metrics 40 and the distribution criteria 60. The AP distributor 59 may then send the computing devices 12-1-12-5 messages that cause the computing devices 12-1-12-5 to redistribute the Aps 24 as directed by the AP distributor 59.

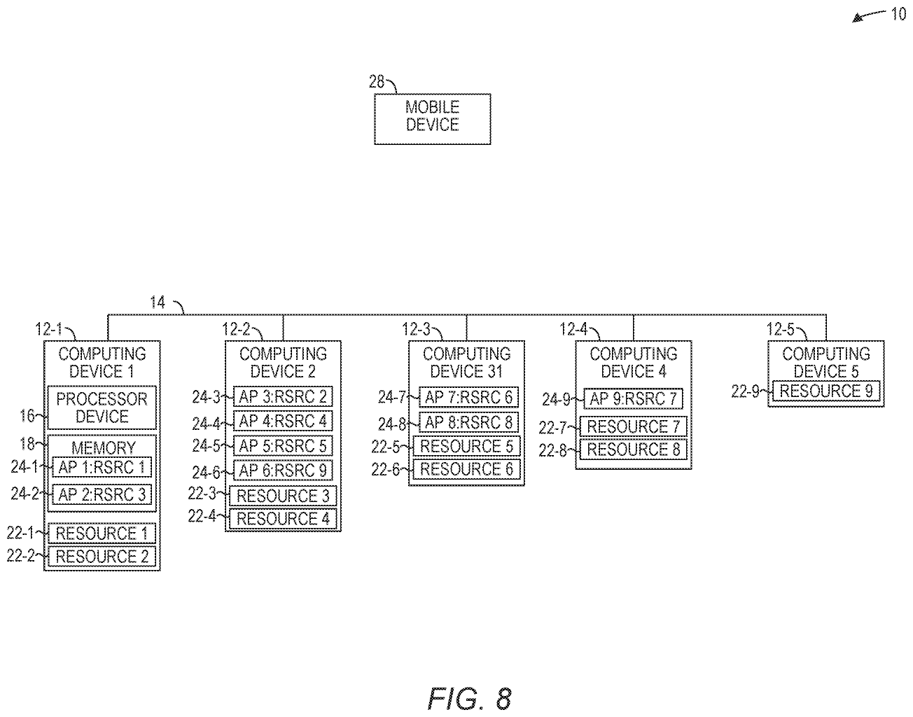

FIG. 8 is a simplified block diagram of the environment 10 illustrated in FIG. 1 according to one implementation. The environment 10 includes the computing device 12-1 that in turn includes the memory 18 and the processor device 16. The processor device 16 is coupled to the memory 18 to receive, via the communications channel 14, from a requesting computing device such as the mobile device 28, an access request that identifies a subject, a resource identifier that identifies a resource, and an action. The computing device 12-1 has the set of access policies 24-1 and 24-2, each access policy 24-1 and 24-2 corresponding to a particular resource 22 of the plurality of resources 22-1-22-9. The processor device 16 is further to determine that the resource identifier identifies the resource 22-2 that is not governed by an access policy 24 in the set of access policies 24-1 and 24-2. The processor device 16 is further to send, to the communications channel 14, the access request. The processor device 16 is further to receive an access request decision from the computing device 12-2 of the plurality of computing devices 12-1-12-2. The processor device 16 is further to grant or deny access to the resource 22-2 by the user based on the access request decision.

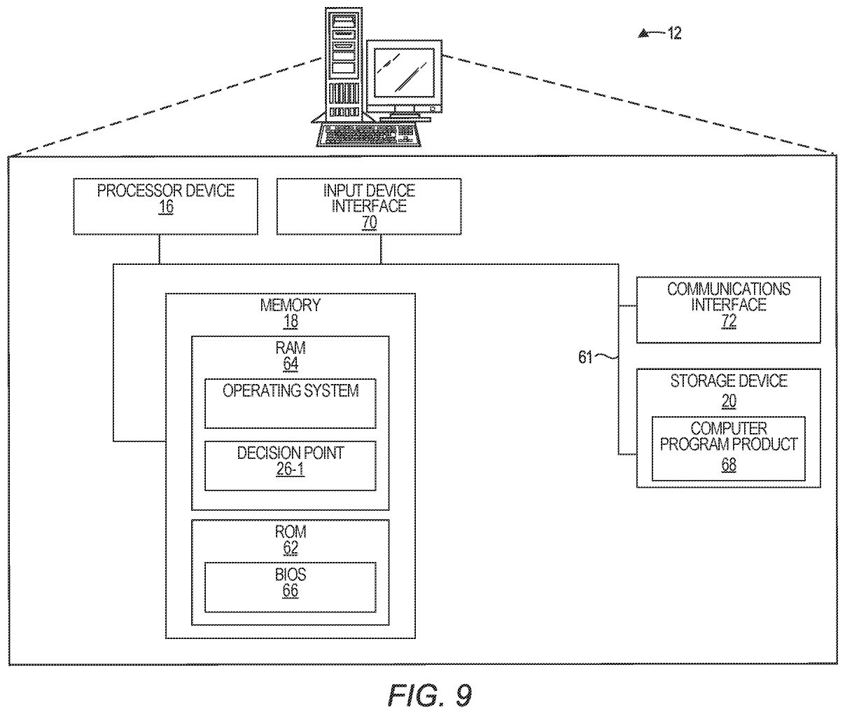

FIG. 9 is a block diagram of a computing device 12 suitable for implementing any of the computing devices 12-1-12-5. The computing device 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 12 includes the processor device 16, the system memory 18, and a system bus 61. The system bus 61 provides an interface for system components including, but not limited to, the system memory 18 and the processor device 16. The processor device 16 can be any commercially available or proprietary processor device.

The system bus 61 may be any of several types of bus structures that may further interconnect to a memory bus (with or without a memory controller), a peripheral bus, and/or a local bus using any of a variety of commercially available bus architectures. The system memory 18 may include non-volatile memory 62 (e.g., read-only memory (ROM), erasable programmable read-only memory (EPROM), electrically erasable programmable read-only memory (EEPROM), etc.), and volatile memory 64 (e.g., random-access memory (RAM)). A basic input/output system (BIOS) 66 may be stored in the non-volatile memory 62 and can include the basic routines that help to transfer information between elements within the computing device 12. The volatile memory 64 may also include a high-speed RAM, such as static RAM, for caching data.

The computing device 12 may further include or be coupled to a non-transitory computer-readable storage medium such as the storage device 20, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 20 and other drives associated with computer-readable media and computer-usable media may provide non-volatile storage of data, data structures, computer-executable instructions, and the like. A number of modules can be stored in the storage device 20 and in the volatile memory 64, including an operating system and one or more program modules, such as the decision point 26, which may implement the functionality described herein in whole or in part. All or a portion of the examples may be implemented as a computer program product 68 stored on a transitory or non-transitory computer-usable or computer-readable storage medium, such as the storage device 20, which includes complex programming instructions, such as complex computer-readable program code, to cause the processor device 16 to carry out the steps described herein. Thus, the computer-readable program code can comprise software instructions for implementing the functionality of the examples described herein when executed on the processor device 16. The processor device 16, in conjunction with the decision point 26 in the volatile memory 64, may serve as a controller, or control system, for the computing device 12 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 16 through an input device interface 70 that is coupled to the system bus 61 but can be connected by other interfaces such as a parallel port, an Institute of Electrical and Electronic Engineers (IEEE) 1394 serial port, a Universal Serial Bus (USB) port, an IR interface, and the like. The computing device 12 may also include a communications interface 72 suitable for communicating with the communications channel 14 as appropriate or desired.

Individuals will recognize improvements and modifications to the preferred examples of the disclosure. All such improvements and modifications are considered within the scope of the concepts disclosed herein and the claims that follow.

What is claimed is:

1. A method comprising:
receiving, by a first computing device of a plurality of computing devices in communication with one another via a communications channel, from a requesting computing device, an access request that identifies a subject, a resource identifier that identifies a resource, and an action, the first computing device having a set of access policies, each access policy corresponding to a particular resource of a plurality of resources;
determining, by the first computing device, that the resource identifier identifies a resource that is not governed by an access policy in the set of access policies;
sending, by the first computing device to the communications channel, the access request;
receiving, by the first computing device, an access request decision from a second computing device of the plurality of computing devices; and
granting or denying access to the resource by the subject based on the access request decision.

2. The method of claim 1 wherein the communications channel comprises a publish/subscribe message bus, and further comprising subscribing, by the first computing device, to the publish/subscribe message bus.

3. The method of claim 1 wherein the resource is a resource controlled by the first computing device, and wherein the access request decision is to grant access to the resource.

4. The method of claim 1 wherein the resource is controlled by a third computing device, and wherein access is granted to the resource, and further comprising:
providing, by the first computing device to the requesting computing device, authentication information that, when presented to the third computing device, validates to the third computing device that the requesting computing device has been granted access.

5. The method of claim 1 wherein the resource is controlled by a third computing device, and wherein access is granted to the resource, and further comprising:
providing, by the first computing device to the third computing device, information identifying the requesting computing device and an indication that the requesting computing device has been granted access to the resource.

6. The method of claim 1 further comprising:
broadcasting, by the first computing device via the communications channel, information that identifies the resources governed by the set of access policies.

7. The method of claim 1 further comprising:
receiving, by the first computing device, a plurality of messages, the plurality of messages identifying, for at least some of the other computing devices of the plurality of computing devices, resources governed by the other computing devices; and
generating, by the first computing device, a data structure that identifies the resources governed by the other computing devices, and for each resource, the corresponding computing device that governs access to the resource.

8. The method of claim 1 wherein the resource is controlled by the second computing device, and further comprising:
sending, by the first computing device to the second computing device, the action;
receiving, by the first computing device from the second computing device, a reply; and
sending, by the first computing device to the requesting computing device, the reply.

9. A computing device, comprising:
a memory; and
a processor device coupled to the memory to:
receive, via a communications channel, from a requesting computing device, an access request that identifies a subject, a resource identifier that identifies a resource, and an action, the first computing device having a set of access policies, each access policy corresponding to a particular resource of a plurality of resources;
determine that the resource identifier identifies a resource that is not governed by an access policy in the set of access policies;
send, to the communications channel, the access request;
receive an access request decision from a second computing device of the plurality of computing devices; and
grant or deny access to the resource by the user based on the access request decision.

10. The computing device of claim 9 wherein the resource is a resource controlled by the first computing device, and wherein the access request decision is to grant access to the resource.

11. The computing device of claim 9 wherein the resource is controlled by a third computing device, and wherein access is granted to the resource, and wherein the processor device is further to:
provide, to the requesting computing device, authentication information that, when presented to the third computing device, validates to the third computing device that the requesting computing device has been granted access.

12. The computing device of claim 9 wherein the resource is controlled by a third computing device, and wherein access is granted to the resource, and wherein the processor device is further to:
provide, to the third computing device, information identifying the requesting computing device and an indication that the requesting computing device has been granted access to the resource.

13. The computing device of claim 9 wherein the processor device is further to:
broadcast, via the communications channel, information that identifies the resources governed by the set of access policies.

14. The computing device of claim 9 wherein the processor device is further to:
receive a plurality of messages, the plurality of messages identifying, for at least some of the other computing devices of the plurality of computing devices, resources governed by the other computing devices; and
generate a data structure that identifies the resources governed by the other computing devices, and for each resource, the corresponding computing device that governs access to the resource.

15. The computing device of claim 9 wherein the resource is controlled by the second computing device, and wherein the processor device is further to:
send, to the second computing device, the action;
receive, from the second computing device, a reply; and
send, to the requesting computing device, the reply.

16. A non-transitory computer-readable storage medium that includes executable instructions to cause a processor device to:
receive, via a communications channel, from a requesting computing device, an access request that identifies a subject, a resource identifier that identifies a resource, and an action, the first computing device having a set of access policies, each access policy corresponding to a particular resource of a plurality of resources;
determine that the resource identifier identifies a resource that is not governed by an access policy in the set of access policies;
send, to the communications channel, the access request;
receive an access request decision from a second computing device of the plurality of computing devices; and
grant or deny access to the resource by the user based on the access request decision.

17. The non-transitory computer-readable storage medium of claim 16 wherein the resource is a resource controlled by the first computing device, and wherein the access request decision is to grant access to the resource.

18. The non-transitory computer-readable storage medium of claim 16 wherein the resource is controlled by a third computing device, and wherein access is granted to the resource, and wherein the processor device is further to:
provide, to the requesting computing device, authentication information that, when presented to the third computing device, validates to the third computing device that the requesting computing device has been granted access.

19. The non-transitory computer-readable storage medium of claim 16 wherein the resource is controlled by a third computing device, and wherein access is granted to the resource, and wherein the processor device is further to:
provide, to the third computing device, information identifying the requesting computing device and an indication that the requesting computing device has been granted access to the resource.

20. The non-transitory computer-readable storage medium of claim 16 wherein the processor device is further to:
broadcast, via the communications channel, information that identifies the resources governed by the set of access policies.
